(19) United States
(12) Patent Application Publication
(10) Pub. No.: US 2004/0010617 A1
(43) Pub. Date: Jan. 15, 2004

(54) Request routing network system, request router apparatus, router apparatus and a method for path setting in a network

(75) Inventors: Shinichi Akahane, Hachioji (JP); Kazuyoshi Hoshino, Komae (JP); Morihito Miyagi, Yokohama (JP); Masahiko Mizutani, Kokubunji (JP); Makoto Kitani, Kokubunji (JP)

Correspondence Address: Stanley P. Fisher, Reed Smith LLP, Suite 1400, 3110 Fairview Park Drive, Falls Church, VA, 22042-4503, US

(73) Assignee: Hitachi, Ltd.

(21) Appl. No.: 10/357,369

(22) Filed: Feb. 4, 2003

(30) Foreign Application Priority Data
Jul. 9, 2002 (JP) 2002-199550

(51) Int. Cl. G06F 15/173

(52) U.S. Cl. 709/243; 709/239

(57) ABSTRACT

A request routing system for offering high-quality, low-priced data delivery services to a large number of users is disclosed. Request router RR1 for redirecting data requests to delivery servers manages the data storage in each delivery server, the MPU load on each delivery server, the delay time involved between delivery servers and terminals, and the bandwidths of data delivery paths between delivery servers and terminals. If a bandwidth required for data delivery cannot be acquired, request router RR1 can perform a calculation to check whether an alternative path can be set between a delivery server and terminal. If the result of the calculation indicates that an alternative path can be set, request router RR1 can explicitly set such a path.

### BACKGROUND OF THE INVENTION

The present invention relates to a request router apparatus for redirecting a data request to a plurality of delivery servers, a request routing network to which the request router apparatus is connected, and a method for path setting in the network.

The network access speed is being increased thanks to an ADSL (Asymmetric Digital Subscriber Line) or other high-speed access technology. Under these circumstances, an IP (Internet Protocol) network is used to initiate services for delivering music data, movies, and other large-size data in addition to WWW (World Wide Web) services for conventional HTML (Hyper Text Markup Language) text delivery. These large-size data delivery services are often pay services. As regards these services, the service providers need to deliver data while assuring the user's contracted high-speed access network bandwidth and an adequate communication quality for the service price.

The communication quality to be assured varies with the style of data delivery and use. If, for instance, the employed data delivery/use style is such that delivered data is used after it is entirely stored in a storage device of a user terminal (e.g., Video on Demand), the communication quality to be considered depends on the period of time between the instant at which the user requests data and the instant at which the requested data is entirely stored. On the other hand, if the employed data delivery/use style is such that received data is sequentially used before it is entirely stored in a storage device of a user terminal (e.g., Voice over IP or live streaming broadcast), the communication quality to be considered depends on the data delivery bandwidth, delay, etc.

Request routing technologies are used for delivering data to a large number of users via a large-scale network while assuring the above-mentioned communication quality. Typical request routing technologies are described in the Internet Draft “Known CN Request-Routing Mechanisms” (draft-ietf-cdi-known-request-routing-00.txt) (hereinafter referred to as Reference Document 1), which is issued by the IETF (Internet Engineering Task Force).

A technology described in Reference Document 1 above is explained with reference to FIG. 2. FIG. 2 indicates that networks 1, 2, and 3 are interconnected. Terminal T1 is connected to network 1. Terminal T2 is connected to network 2. Within network 3, original server S3 is provided for the storage of original data. Networks 1 and 2 are provided with delivery servers S1 and S2, respectively. The original data retained in the S3 is copied in advance to the S1 and S2. The pull, push, or other method is used to copy the original data to the delivery servers. When the pull method is used, the delivery servers independently request the original server to distribute latest data. When the push method is used, on the other hand, the original server distributes latest data to each delivery server. Network 3 is also provided with request router RR1, which selects a delivery server that is capable of delivering data requested by a terminal while assuring the user-requested communication quality and redirecting the associated data request to the selected server. The RR1 observes types of data retained in each of the delivery server, the MPU load on the delivery servers, and the delay time and extra bandwidth related to the delivery path between the delivery servers and user terminal; and manages the information derived from such observation operations.

Next, the request routing process operation will be described. The T1 first transmits a data request to the RR1. In FIG. 2, the data request is indicated by arrow 21. Upon receipt of the data request, the RR1 selects an optimum delivery server for data delivery to the T1 while considering the information indicating whether the requested data is stored in the delivery servers, the MPU load on the delivery servers, and the delay time, extra bandwidth, and other elements involved in the delivery path to the T1. Subsequently, the RR1 notifies the T1 that the S1 is the optimum server. The information delivered in this case can be the S1's IP (Internet Protocol) address. In FIG. 2, this notification is indicated by arrow 22. After being informed that the S1 is the optimum server, the T1 sets a TCP (Transmission Control Protocol) connection or the like for the S1. In FIG. 2, this connection setting is indicated by arrow 23. The T1 uses the connection set in this manner to acquire data from the S1. In FIG. 2, this data acquisition is indicated by arrow 24.

The use of a technology described in Reference Document 1 above makes it possible to distribute data requests from the terminals to a plurality of delivery servers, which are positioned diffusely near the terminals. In marked contrast to situations where the original server processes all data requests from the terminals, the use of the above-mentioned technology also reduces the delay time involved in the delivery path and minimizes the possibility of data delivery communication quality deterioration due to congestion in the delivery path. Further, the above-mentioned technology provides a means of distributing the data requests from the terminals in accordance with the MPU load on the delivery servers, thereby making it possible to deliver data to a large number of terminals while assuring the communication quality.

For delivering data to a large number of users at a low price while assuring the above-mentioned communication quality, a network resource use technology for data delivery is effective in addition to the technologies disclosed in Reference Document 1. A traffic engineering technology based on MPLS (Multi-Protocol Label Switching) is available as the effective network resource use technology. MPLS is described, for instance, in the RFC (Request For Comment) 3031 “Multiprotocol Label Switching Architecture” (hereinafter referred to as Reference Document 2), which is issued by the IETF (Internet Engineering Task Force) Further, the MPLS-based traffic engineering technology is outlined, for instance, in the RFC 2702 “Requirements for Traffic Engineering Over MPLS”, which is issued by the IETF.

The use of the technology disclosed in Reference Document 2 above makes it possible to select paths explicitly and distribute part of the traffic to the selected paths, thereby decentralizing the load on congested points in a network. Since this technology also permits effective use of network resources, it can reduce the cost of data delivery.

However, when the technologies disclosed in Reference Documents 1 and 2 are used to provide low-priced data delivery services to a large number of users while assuring the communication quality, they cause problems, which are described below.

When the technologies disclosed in Reference Document 1 are used, the request router selects an optimum delivery server for data delivery to a terminal in accordance with the MPU load on the delivery servers and the load on the delivery path between the delivery servers and terminal. However, they do not dynamically control the network status. Therefore, they do not always permit effective use of both the server resources and network resources.

For example, the request router may conclude that a server candidate cannot assure the user-requested communication quality due to a congestion in a delivery path although the delay involved in a delivery path is minimized with the MPU load rendered small, and then select another delivery server that would increase the delay time. If such a server selection is made, the extra resources of a server whose MPU load is small will not be used. Further, even if there are the network's extra resources near a path congested as mentioned above, such extra resources will not be used.

Furthermore, the explicit path setting method disclosed in Reference Document 2 merely allows the network administrator and path management server to observe and manage the network quite independently of data requests from users, and cannot dynamically set a path to acquire a bandwidth in response to a data request.

### SUMMARY OF THE INVENTION

The first object of the present invention is to offer a request routing network that provides a low-priced, high-quality data delivery service to a large number of users by dynamically controlling the network status in response to data requests.

The second object of the present invention is to offer a path setting method, which uses a request router apparatus, router apparatus, and other associated devices connected to the aforementioned request routing network in order to dynamically control the bandwidth on a delivery path between delivery servers and terminals in response to aforementioned data requests and set a new path to increase the bandwidth if it is insufficient.

To solve the above problems and dynamically control the network status in response to data requests to offer a low-priced, high-quality data delivery service to a large number of users, one preferred aspect of the present invention resides in a request routing network system in which a plurality of routers interconnect a plurality of servers that retain a copy of at least one type of data, a plurality of terminals that issue requests for such data, and a request router that redirects said data requests to said plurality of servers, and said request router requests one of the routers connected close to said servers to perform a path calculation and path setup for delivering said data before redirecting received data requests to said servers.

Other and further objects, features and advantages of the invention will appear more fully from the following description.

### BRIEF DESCRIPTION OF THE DRAWINGS

FIG. 1 is a diagram that shows a typical structure of request router RR1 of the present invention;

FIG. 2 is a diagram that outlines a conventional request routing technology;

FIG. 3 is a diagram that shows a typical network configuration to which a request router of the present invention is applied;

FIG. 4 is a flowchart that shows a typical request routing process of the present invention;

FIG. 5 is a diagram that shows a typical structure of a data request message/authentication request message;

FIG. 6 is a diagram that shows a typical structure of a data response message/authentication response message;

FIG. 7 is a diagram that shows a typical structure of a path calculation & path setting request message of the present invention;

FIG. 8 is a diagram that shows a typical structure of a path calculation & path setting response message of the present invention;

FIG. 9 is a diagram that shows a typical structure of a path setting request message;

FIG. 10 is a diagram that shows a typical structure of a path setting response message;

FIG. 11 is a diagram that shows a typical structure of router R12's label table;

FIG. 12 is a diagram that shows a typical structure of router R13's label table;

FIG. 13 is a diagram that shows a typical structure of router R11's label table;

FIG. 14 is a flowchart of a process that is different from a request routing process of the present invention, which is shown in FIG. 4;

FIG. 15 depicts data delivery paths in a typical network configuration to which a request router of the present invention is applied;

FIG. 16 depicts data delivery paths in a typical network configuration to which a conventional request router is applied;

FIG. 17 is a diagram that shows a typical structure of a user information table, which is stored within request router RR1 of the present invention;

FIG. 18 is a diagram that shows a typical structure of a data management table, which is stored within the request router RR1 of the present invention;

FIG. 19 is a diagram that shows a typical structure of a delivery server information table, which is stored within the request router RR1 of the present invention;

FIG. 20 is a diagram that shows a typical structure of a delivery path information table, which is stored within the request router RR1 of the present invention;

FIG. 21 shows delivery path information table settings that differ from those in FIG. 20; and

FIG. 22 is a block diagram of a router apparatus (e.g., R11, R12, or R13) that is within a request routing network system shown in FIG. 3.

### DETAILED DESCRIPTION OF THE PREFERRED EMBODIMENTS

This invention will be described in further detail by way of example with reference to the accompanying drawings, wherein like reference characters designate corresponding parts in the several views.

A preferred embodiment of a request routing network system according to the present invention is described below with reference to FIG. 3. FIG. 3 shows a typical network configuration that uses a request routing method according to the present invention. A plurality of networks shown in FIG. 3 are designated networks 1, 2, and 3, respectively. Network 1 comprises routers R11, R12, and R13. The R11 is connected to the line between the R11 and R13 via interface IF11_13. The R13 is connected to the line between the R13 and R12 via interface IF13_12. The R12 is connected to the line between the R12 and T1 via interface IF12_1. Network 2 comprises routers R21, R22, and R23. Network 3 comprises router R31, original data server S3, and request router RR3. User terminal T1 is connected to router R12 of network 1. Delivery server S1 is connected to router R11 of network 1. User terminal T2 is connected to router R22 of network 2. Delivery server S2 is connected to router R23 of network 2.

Routers R11, R12, R13, R21, R22, and R23 have a function for processing an MPLS label distribution protocol such as “Extensions to Resource Reservation Protocol for LSP Tunnels” (RSVP-TE) or “Constraint-based Routing Label Distribution Protocol” (CR-LDP). Routers R11, R12, R13, R21, R22, and R23 are also capable of performing an OSPF (Open Shortest Path Fast) or IS-IS (Intermediate System-to-Intermediate System) process that is extended for traffic engineering. The description of OSPF that is extended for traffic engineering is given in the Internet Draft “Traffic Engineering Extensions to OSPF” (draft-katz-yeung-ospf-traffic-06.txt), which is issued by the IETF. The description of IS-IS that is extended for traffic engineering is given in the Internet Draft “IS-IS extensions for Traffic Engineering” (draft-ietf-isis-traffic-04.txt), which is issued by the IETF.

Routers R11, R23, and R31, which are the closest to servers S1, S2, and S3, respectively, have a function for receiving a path calculation & path setting request from the RR1, calculating a new path for acquiring a requested bandwidth, and activating a path setting with a label distribution protocol such as RSVP-TE or CR-LDP.

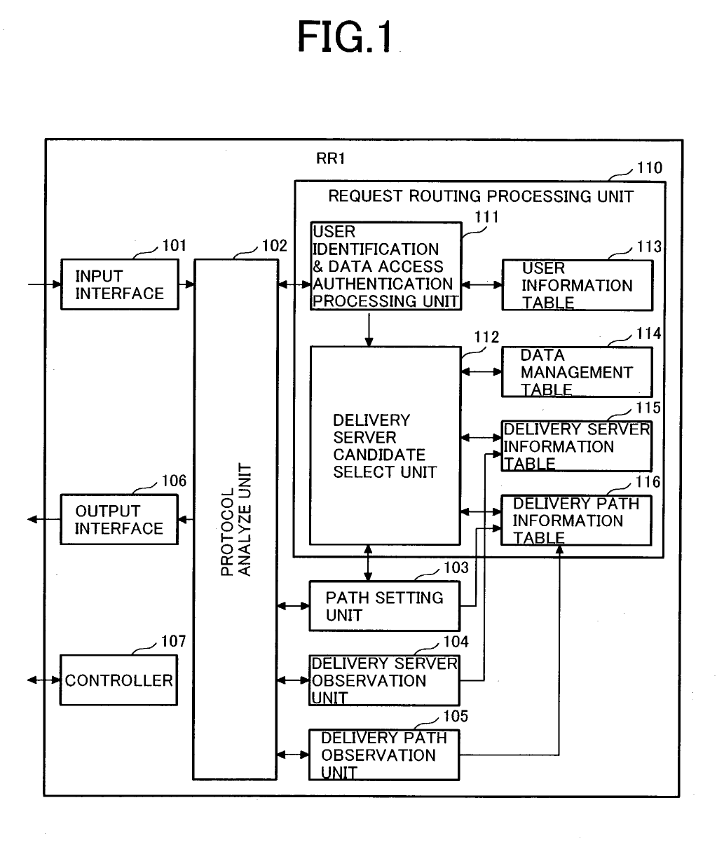

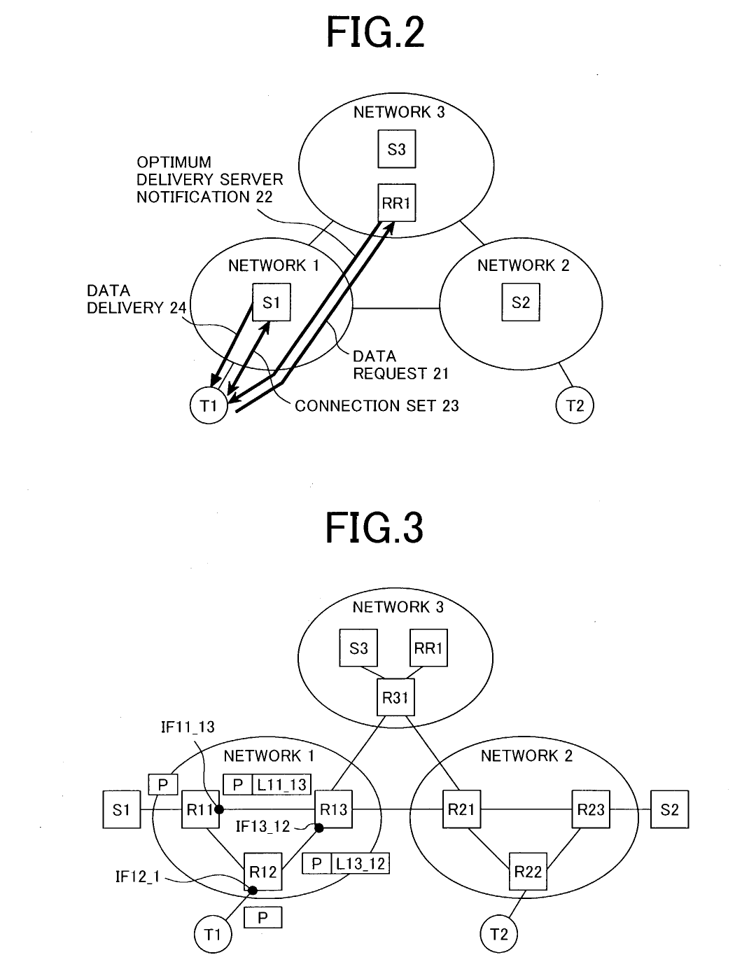

The contents of packet P that is labeled “L11_{—}13” and transferred between routers R11 and R13 shown in FIG. 3 and packet P that is labeled “L13_{—}12” and transferred between routers R13 and R12 will be detailed when table descriptions are given later with reference to FIGS. 1, 12, and 13.

FIG. 1 shows a typical configuration of request router RR1 according to the present invention. The request router RR1 comprises an input interface 101, a protocol analyze unit 102, a request routing processing unit 110, a path setting processing unit 103, a delivery server observation unit 104, a delivery path observation unit 105, an output interface 106, and a controller 107. The request routing processing unit 110 comprises a user identification & data access authentication processing unit 111, a delivery server candidate select unit 112, a user information table 113, a data management table 114, a delivery server information table 115, and a delivery path information table 116. Components 101 through 116 of the request router RR1 may be implemented either by dedicated hardware or software programs running on a general-purpose computer comprising a network interface, MPU, memory, etc.

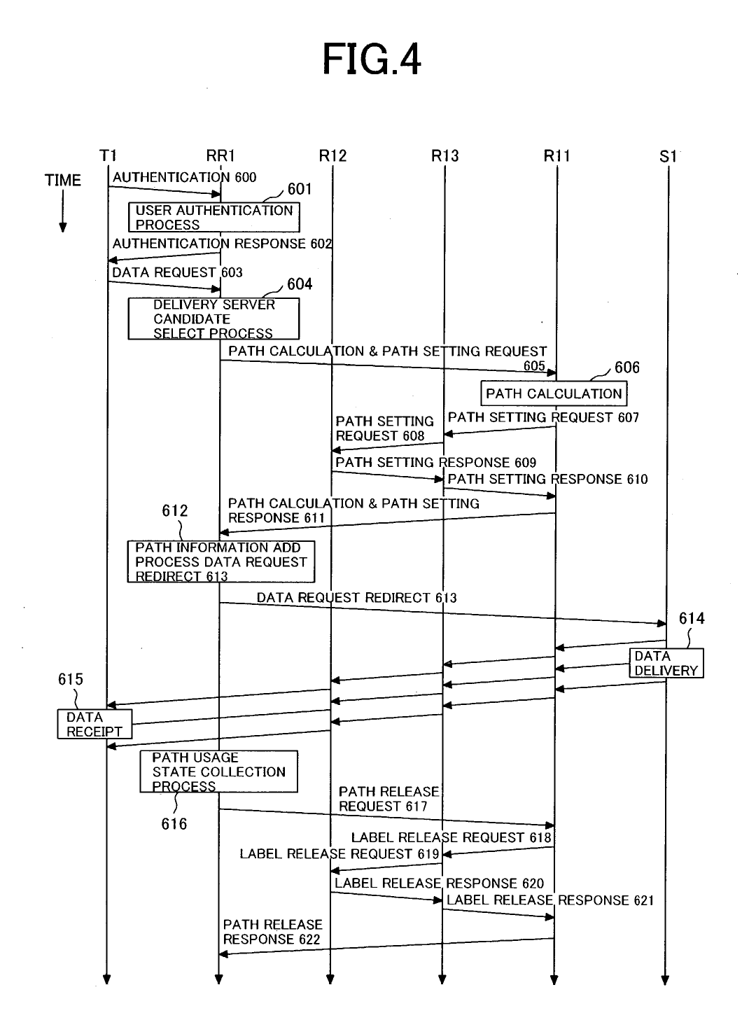

Next, a typical request routing process in which the RR1 redirects the T1's data request to an appropriate delivery server will be described with reference to. FIG. 4. In an example explained below, a connection-oriented protocol such as TCP (Transmission Control Protocol) is used as a four-layer protocol for an OSI (Open System Interconnection) model to provide communication between the T1 and the RR1 and data transfer between the T1 and delivery servers. However, if the reliability of four-layer data transfer is not required, UDP (User Datagram Protocol) or like protocol can be used. As a three-layer protocol, IP (Internet Protocol) or the like is used. As a two-layer or fewer-layer protocol, SONET/SDH (Synchronous Optical Network/Synchronous Digital Hierarchy), Ethernet (registered trademark), ATM (Asynchronous Transfer Mode) MPLS (Multi-Protocol Label Switching), or the like can be used.

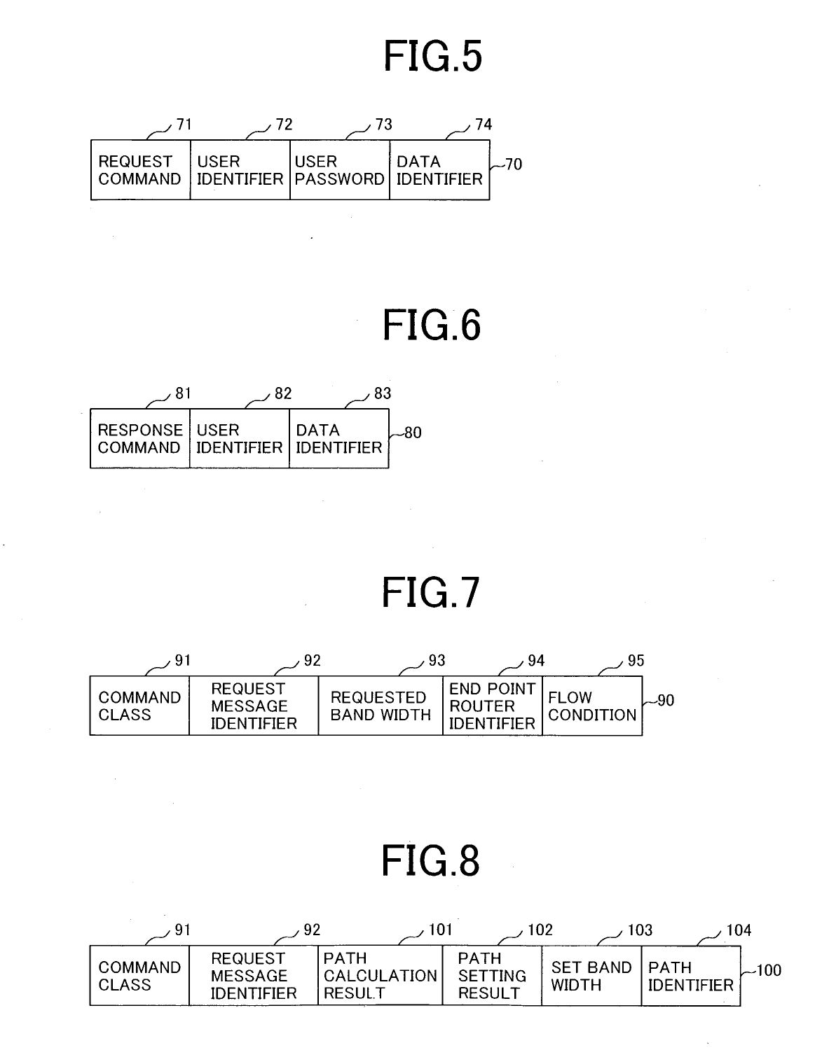

The T1 first establishes a communication connection to the RR1. In FIG. 4, however, the connection establishment is not shown. Next, the T1 issues a user authentication request 600 to the RR1 to ask the RR1 whether the user of terminal T1 is authorized. FIG. 5 shows the structure of a request message that is transmitted from the T1 to the RR1. FIG. 5 indicates that the request message 70 for an authentication request 600 consists of four fields, which carry a request command 71, a user identifier 72, a user password 73, and a data identifier 74, respectively. The field for the request command 71 indicates the contents of a process that a request message generation source device requests a destination device to perform. The request command 71 may, for instance, represent a user authentication, data read, or data write request. The information provided by the user identifier 72 and user password 73 is used to authenticate the T1 user and check whether the user has the right to use a specified request command 71. The data identifier 74 is a directory name/file name, URL (Uniform Resource Locator) or URI (Uniform Resource Identifier) for HTTP, or other item of information that indicates the logical location of data to be processed by a request destination in compliance with the request command 71.

In response to the T1's user authentication request 600 (FIG. 4) to the RR1, the RR1 performs a user authentication process 601 and then returns a user authentication response 602 to the T1. FIG. 6 shows a typical structure of a response message 80 that is used for the user authentication response 602. The response message 80 consists of three fields, which carry a response command 81, a user identifier 82, and a data identifier 83, respectively. The response command 81 carries a process specified by the request command and its status, that is, the information indicating, for instance, whether the process is completed or unsuccessfully ended. The user identifier 82 is the information that identifies the user that should receive a response. The data identifier 83 is the information that indicates the logical location of processed data. After noting the user authentication response 602 to verify that the T1 user is authorized, the T1 transmits a data request 603 to the RR1.

Upon receipt of the data request 603 from the T1, the RR1 performs a delivery server candidate select process 604. The details of the delivery server candidate select process 604 will be given later. Various delivery server candidate selection process policies can be applied to the delivery server candidate select process 604. For the description of a presently preferred embodiment, the server candidate selection process policy explained below is used. According to the server candidate selection process policy applied to the description of the presently preferred embodiment, a plurality of deliver servers are first checked to make a selection for providing the shortest delay time between the delivery server and terminal and the lightest MPU load on the delivery server. FIG. 4 shows a case where the S1 is selected as a candidate delivery server according to the above-mentioned policy. A subsequent check is then conducted to check whether a bandwidth required for data delivery can be acquired on the path (hereinafter referred to as the delivery path) between the delivery server candidate S1 and terminal T1.

If the necessary bandwidth cannot be derived from the delivery path, a path calculation & path setting request 605 is used to ask router R11, which is the router closest to candidate delivery server S1, whether a new delivery path can be set between the S1 and T1 to acquire the required bandwidth. The router closest to the delivery server is hereinafter referred to as the start point router. The router closest to the terminal is hereafter referred to as the end point router. In FIG. 3, the R11 is the start point router for the delivery path between the S1 and T1, and the R12 is the end point router. The RR1 may establish a connection to the R11 before transmitting the path calculation & path setting request 605. However, such a connection establishment is not shown in FIG. 4.

FIG. 7 shows a typical structure of a path calculation & path setting request message 90, which is used for the path calculation & path setting request 605 shown in FIG. 4. The path calculation & path setting request message 90 consists of five fields, which carry a command class 91, a request message identifier 92, a requested bandwidth 93, an end point router identifier 94, and a flow condition 95, respectively. The command class 91 is used to identify the type of message that is exchanged between start point router R11 and the RR1 that issues the path calculation & path setting request 605 or response. The value stored in the field of the command class 91 indicates whether the message carries a request or response. The request message identifier 92 is used to establish the correlation between a plurality of path calculation & path setting request messages 90 that request router RR1 transmits and a plurality of response messages that the request router receives from the other routers. The requested bandwidth 93 is the bandwidth that should be acquired on a new path to be set between start point router R11 and end point router R12. The end point router identifier 94 indicates the end point router for the path to be newly calculated. In the presently preferred embodiment, the IP address value of the end point router is stored in the end point router identifier field.

Next, the flow condition 95 will be described. The flow condition field is an aggregate of packets that should be subjected to the same communication quality control at a router. The flow condition is to be defined using the packet IP (Internet Protocol) header information or TCP (Transmission Control Protocol) header information. In the presently preferred embodiment, all the packets composing the data to be delivered from the S1 to T1 are required to assure the same communication quality. Therefore, the aggregate of such packets is defined as a flow to assure the same communication quality for the aforementioned flow condition. For defining the above flow, the presently preferred embodiment defines the flow of data to be delivered from the S1 to the T1 in such a manner that the destination IP address is equal to the T1's IP address and that the source IP address is equal to the S1's IP address, and stores the above condition in the field of the flow condition 95 in the path calculation & path setting request message 90 shown in FIG. 7. This flow definition can be freely edited according to the RR1 administrator's policy.

Upon receipt of the path calculation & path setting request 605, the R11 performs a calculation (step 606) with the requested bandwidth 93 and end point router identifier 94 in the path calculation & path setting request message 90 to determine whether a new path can be set between the R11 and R12 to acquire the requested bandwidth 93 (FIG. 4). In the presently preferred embodiment, the above calculation is performed using an OSPF process extended for traffic engineering or a traffic engineering database based on individual router link bandwidth information distributed by an IS-IS process and the Constrained Shortest Path Fast (CSPF) algorithm, which uses the above TE (traffic engineering) database to calculate the path for acquiring the requested bandwidth 93. Each router uses the OSPF process extended for traffic engineering or the IS-IS process to convey the link information accommodated by each router, such as the information about the available total bandwidth, reservable total bandwidth, and reservable-but-unreserved bandwidth. On the basis of these items of information, a TE database is then constructed within each router. In accordance with the TE database, each router uses the CSPF algorithm to calculate a path for acquiring the requested bandwidth. When the result of the above path calculation indicates that an existing path can acquire the requested bandwidth 93, the R11 uses a list of routers on the above path and issues a path setting request to router R13, which is located upstream one level (step 607) (FIG. 4).

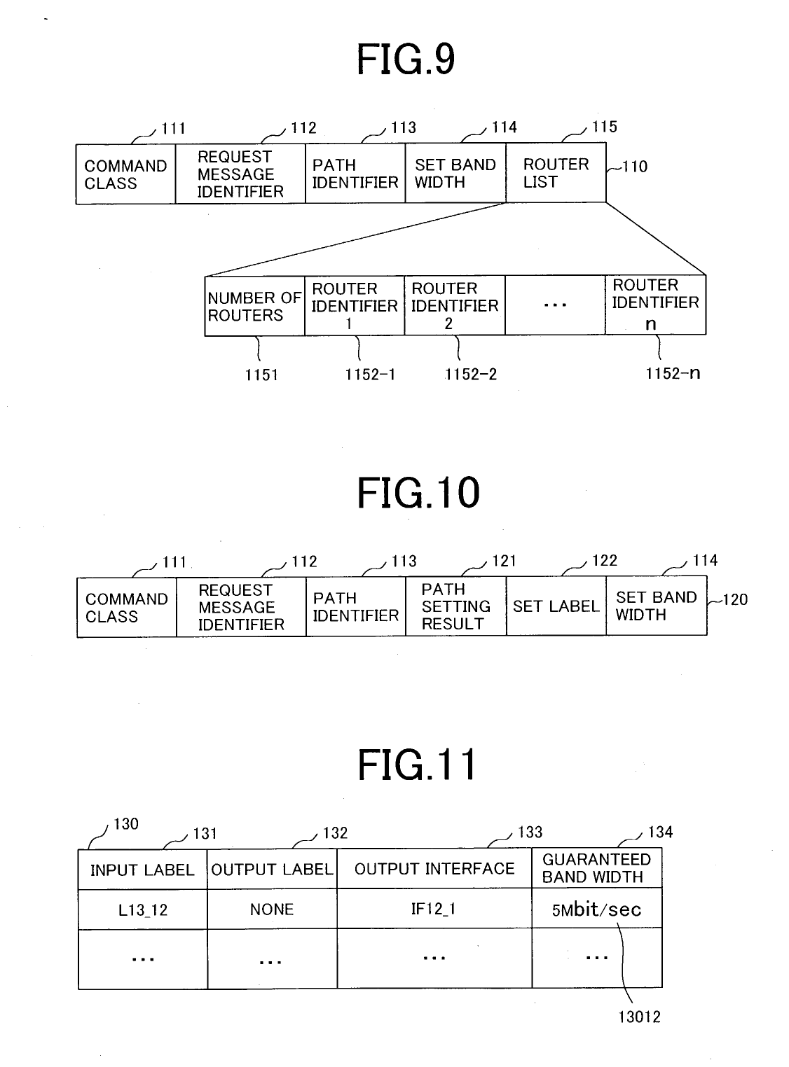

FIG. 9 shows a typical structure of a path setting request message 110, which is used for a path setting request 607, 608 shown in FIG. 4. The path setting request message 110 consists of five fields, which carry a command class 111, a request message identifier 112, a path identifier 113, a set bandwidth 114, and a routers list 115, respectively. The command class 111 is used to identify the type of message exchanged between routers. The value stored in the field of the command class indicates whether the message carries a request or response. The request message identifier is used to establish the correlation between a plurality of path setting request messages that the start point router for making a path setting request transmits and a plurality of path setting response messages that the start point router receives from the other routers. The path identifier is used to identify the path to be newly set. The set bandwidth 114 is used as the set value for an individual router's bandwidth guarantee function. Each router complies with this set value and transfers packets transmitted over the set path while guaranteeing the bandwidth. The routers list 115 consists of a field for indicating the number of routers 1151 and fields for a plurality of router identifiers 1152-n (n=the setting for the number of routers 1151) on the new path to be set. When the router identifiers 1152-i (i=1 to n) in the above routers list are referenced, it is possible to select the router to which the path setting request should be transferred next, and transfer the path setting request message.

Upon receipt of the path setting request as indicated in FIG. 4, the R13 notes the routers list 115 in the path setting request message, selects the R12 as the router to which the path setting request message should be transmitted next, and transmits the path setting request message to the R12 (step 608). Upon receipt of the above path setting request message, the R12 notes the routers list in the path setting request message and recognizes that the R12 is the end point for the new path setting. Subsequently, the R12 selects the upstream router R13 MPLS label for the new path to be set, and stores the value of the label in a label table within the R12. Further, the R12 sets the value that is stored in the set bandwidth field 114 within the path setting request message 110 as the bandwidth value guaranteed for packets that are given the above MPLS label.

FIG. 11 shows a typical structure of the label table in the R12 and its setting example. The R12's label table 130 comprises a set of entries for an input label 131, an output label 132, an output interface 133, and a guaranteed bandwidth 134. When the above process for storage into the label table is performed, entry 13012 is newly registered. The input label for entry 13012 is the value that is determined by the R12. In the setting example shown in the figure, the label “L13_{—}12” is set. The output label is set to “None” because the R12 is an output edge router for MPLS network 1. Therefore, the input packet is stripped of its MPLS label and then transferred to the T1 as an IP packet. The output interface for entry 13012 is set to “IF12_{—}1” to which the T1 is connected. The guaranteed bandwidth for entry 13012 is set to “5 Mbps” in the presently preferred embodiment.

After label table entry 13012 is set, the R12 returns a path setting response to the R13 (step 609).

FIG. 10 shows a typical structure of a path setting response message, which is used for a path setting response 609, 610 shown in FIG. 4. The path setting response message 120 consists of a command class 111, a request message identifier 112, a path identifier 113, a path setting result 121, a set label 122, and a set bandwidth 114. The command class 111, request message identifier 112, path identifier 113, and set bandwidth 114 are the same as the contents of the associated fields in the path setting request message 110. The path setting result 121 indicates whether the downstream router path is successfully set. If the value stored in the field of the path setting result 121 indicates that path setup has been “Unsuccessful”, a router receiving the path setting response message 120 transmits the path setting response message to an upstream router without performing label table setup or guaranteed bandwidth value setup. In this instance, the field of the path setting result 121 within the path setting response message 120 to be transmitted by the router stores the same “Unsuccessful”-indicating value as the setting in the path setting result field in the received path setting response message 120. When the value stored in the field of the path setting result 121 indicates that path setup has been “Successful”, on the other hand, a router receiving the path setting response message 120 selects an MPLS label for an upstream router, performs storage in the label table, sets a bandwidth, and then transmits the path setting response message to an upstream router. The field of the set label 122 stores the MPLS label that the router receiving the path setting response message has selected for an upstream router. Upon receipt of the path setting response message 120 from the R12, the R13 selects upstream router R11's MPLS label for the new path to be set, performs storage in the label table within the R13, and sets a bandwidth in the same manner as the R12.

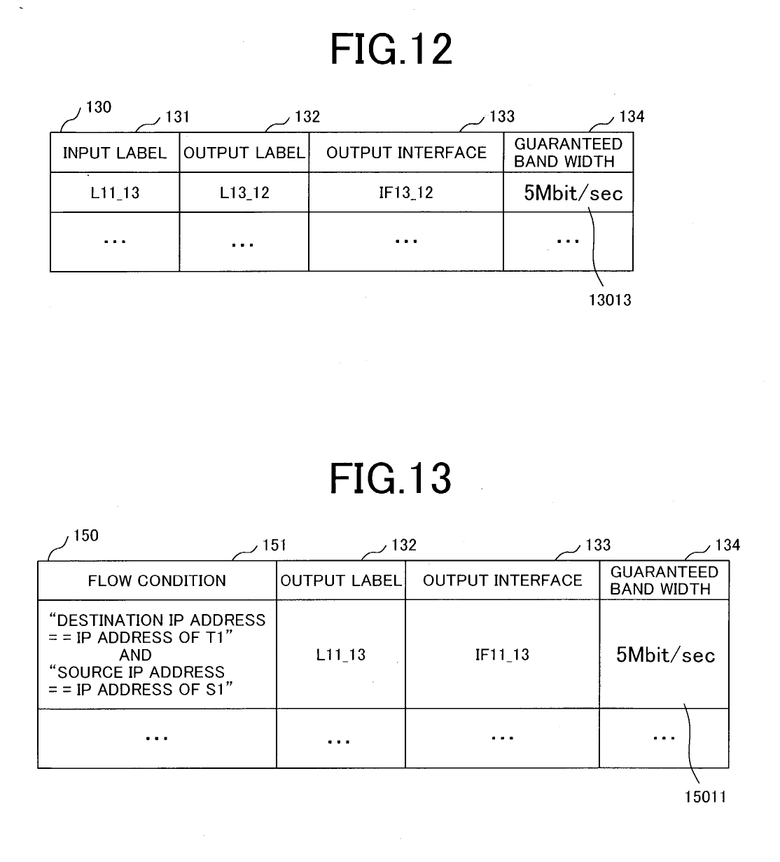

FIG. 12 shows a typical structure of the label table in the R13 and its setting example. The structure of the R13 label table is the same as that of the R12's label table 130. The input label value for entry 13013, which is to be newly registered, is determined by the R13. In the setting example shown in the figure, it is set to “L11_{—}13”. For the output label for entry 13013, the value stored in the set label field of the path setting response message received from the R12 is set. In the presently preferred embodiment, the value “L13_{—}12” is set as it is the R13 label value determined by the R12. For the output interface for entry 13013, “TF13_{—}12” is set because the R12 is connected to it. The value set in the guaranteed bandwidth field for entry 13013 is the same “5 Mbps” as for the R12.

After label table entry 13013 is set, the R13 returns a path setting response to the R11 (step 610). Upon receipt of the path setting response message from the R13, the R11 selects upstream router R11's MPLS label for the new path to be set, performs storage in the label table within the R13, and sets a bandwidth in the same manner as the R12.

FIG. 13 shows a typical structure of the label table in the R11 and its setting example. Since the R11 is an input edge router for an MPLS network, the R11's label table 150 consists of a flow condition 151, an output label 132, an output interface 133, and a guaranteed bandwidth 134. When the above process for storage into the label table is performed, entry 15011 is newly registered. In the field of the flow condition 151 for entry 15011, the flow definition stored in the flow condition field of the path calculation & path setting request message received from the RR1 is set. The flow definition set in the setting example shown in the figure is such that the destination IP address is equal to the T1's IP address and that the source IP address is equal to the S1's IP address.

As the output label for entry 15011, the value stored in the set label field of the path setting response message 120 received from the R13 is set. In the presently preferred embodiment, the value “L11_{—}13” is set as it is the R11 label value determined by the R13. For the output interface for entry 15011, “IF11_{—}13” is set because the R13 is connected to it. The value set in the guaranteed bandwidth field for entry 15011 is the same “5 Mbps” as for the R13.

After label table entry 15011 is set, the R11 performs a path calculation/path setting response process in relation to the RR1 (step 611). FIG. 8 shows a typical structure of a path calculation & path setting response message 100, which is used for a path calculation & path setting response 611 shown in FIG. 4. The path calculation & path setting response message 100 consists of six fields, which carry a command class 91, a request message identifier 92, a path calculation result 101, a path setting result 102, a set bandwidth 103, and a path identifier 104, respectively. The command class 91 and request message identifier 92 are the same as the contents of the associated fields in the path calculation & path setting request message 90 (FIG. 7). The field of the path calculation result 101 stores the result of the path calculation performed in the R11. When a calculated path permits the acquisition of the requested bandwidth, the value stored in this field indicates that the path calculation has been “Successful”. If such a path calculation is not successfully done, the value stored in this field indicates that the path calculation has been “Unsuccessful”. The value set in the field of the path setting result 102 indicates whether path setup is successful when the path calculation is successfully done as above. When path setup is successfully completed, the value in this field indicates that path setup has been “Successful”. If path setup is not successfully achieved, the value in this field indicates that path setup has been “Unsuccessful”. The value stored in the field of the set bandwidth indicates a bandwidth that is actually set when path setup has been successful. In the presently preferred embodiment, the set bandwidth value is equal to the value of the requested bandwidth 93 within the path calculation & path setting request message 90. A method other than described in the presently preferred embodiment may be alternatively used to set a value in the above set bandwidth field even if it is not equal to the value in the requested bandwidth field within the path calculation & path setting request message.

An alternative method is to furnish the path calculation & path setting request message 90 with a flag for indicating the stringency of the requested bandwidth 93. The value of this flag can be used to afford an appropriate margin for the requested bandwidth. When the stringency flag says “Stringent”, the start point router performs a calculation so as to acquire the requested bandwidth. If no appropriate path is found as a result of the calculation, the start point router sends a notification to indicate that path setup has been “Unsuccessful”. If no appropriate path is found in situations where the stringency flag says “Not stringent”, the start point router may perform a calculation again in order to acquire half the requested bandwidth. If a path providing half the request bandwidth is found as result of the recalculation, the value indicating “Successful” is stored in the field of the path calculation result 101 within the path calculation & path setting response message 100 with the value equivalent to half the requested bandwidth stored in the field of the set bandwidth 103. When the received path calculation & path setting response message 100 indicates the above condition, the RR1 may subtract the set bandwidth from the requested bandwidth and request the resulting bandwidth value by issuing a path calculation & path setting request to another start point router. When the above alternative method is used, network resources can be used more efficiently than performing a stringent path calculation on the requested bandwidth and returning a response to indicate that the path calculation has been unsuccessful.

The path identifier is used so that the RR1 manages a newly set path as a delivery path. If the set bandwidth for the newly set path has a margin, the path can be counted as a delivery path when a delivery server for redirecting a data request from another terminal is to be selected.

Upon receipt of the path calculation & path setting response 611, the RR1 adds newly set path information (set bandwidth, path identifier, etc.) to the delivery path information table 116 within the RR1 (step 612). Subsequently, the RR1 redirects a data request from the T1 to the S1 (step 613).

Upon receipt of the data request redirected by the RR1, the S1 uses the data identifier 74 in a request message 70 (FIG. 5) to decide on the data to be delivered, and then delivers the data to the T1 (step 614).

Before transmission, the S1 divides the data into a plurality of IP packets. Upon receipt of the IP packets from the S1, the R11 uses the received packet header information as a search key to search for the label table explained with reference to FIG. 13. In the presently preferred embodiment, the destination IP address and source IP address are extracted from the packet header information to search the label table for an entry whose flow condition 151 matches the extracted destination IP address and source IP address. Data packets transmitted from the S1 to the T1 agree with the flow condition specified for entry 15011 in FIG. 13.

Therefore, the search result indicates that the output label is “L11_{—}13”, and that the output interface is “IF11_{—}13”, and further that the guaranteed bandwidth is “5 Mbps”. In accordance with this search result, the R11 attaches the label “L11_{—}13” to the IP packets as shown in FIG. 3, and transfers the packets from output interface IF11_13 to the R13 while guaranteeing a bandwidth of 5 Mbps. Upon receipt of the packets from the R11, the R13 uses the received packet label as a search key to search the label table explained with reference to FIG. 12. In the presently preferred embodiment, the label table is searched for an entry whose input label 131 matches the value of the label attached to the packets. Since the received packets are given the label “L11_{—}13” by the R11, they match the value set in the input label field for entry 13013 shown in FIG. 12. Therefore, the search result indicates that the output label is “L13_{—}12”, and that the output interface is “IF13_{—}12”, and further that the guaranteed bandwidth is “5 Mbps”. In accordance with this search result, the R13 replaces the IP packet label “L11_{—}13” with “L13_{—}12” as indicated in FIG. 3, and transfers the packets from output interface IF13_12 to the R12 while guaranteeing a bandwidth of 5 Mbps. Upon receipt of the packets from the R13, the R12 uses the received packet label as a search key to search the label table explained with reference to FIG. 11. As is the case with the R13, the R12 searches the label table for an entry whose input label 131 matches the value of the label attached to the packets. Since the received packets are given the label “L13_{—}12” by the R13, they match the value set in the input label field for entry 13012 shown in FIG. 11. Therefore, the search result indicates that the output label is “None”, and that the output interface is “IF12_{—}1”, and further that the guaranteed bandwidth is “5 Mbps”. In accordance with this search result, the R12 removes the label “L13_{—}12” from the IP packets and transfers the packets from output interface TF12_1 to the T1 while guaranteeing a bandwidth of 5 Mbps. Subsequently, the T1 receives the IP packets that are transferred from the R12 (step 615).

A request routing process in which a new path for guaranteeing a bandwidth is set in compliance with a data request from the T1 and the data request is redirected to the S1 has been described. The aforementioned IP packet is represented by reference symbol P as shown in FIG. 3. The contents of the IP packet are not always the same.

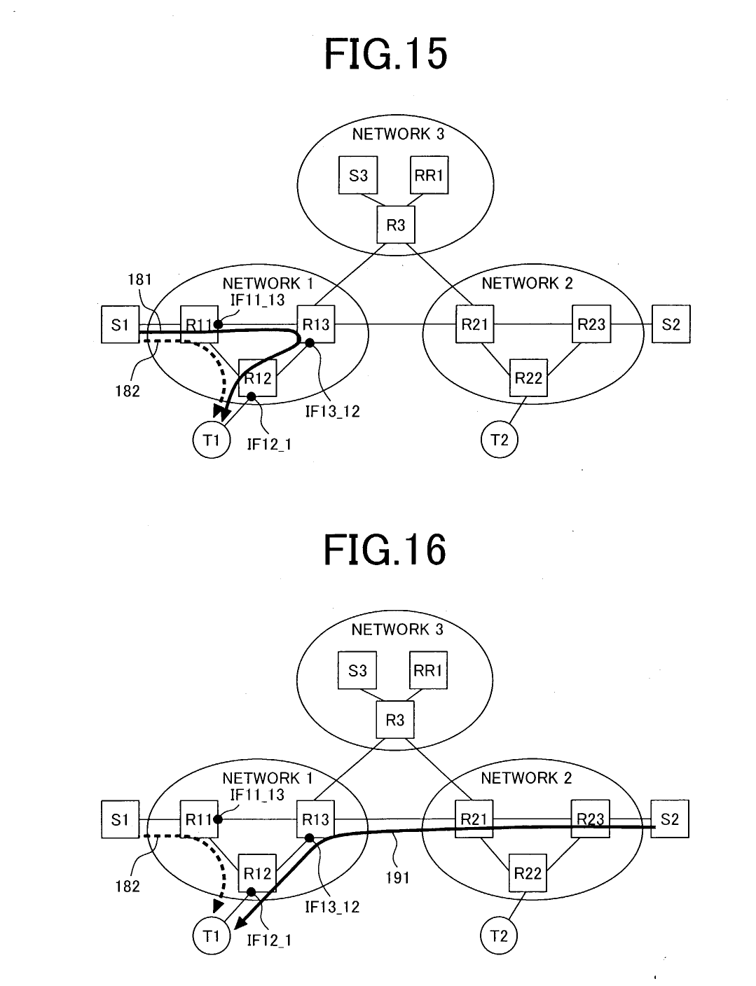

Next, FIGS. 15 and 16 are used to explain the request redirection destination and data transfer path differences between a request routing network system of the present invention and a request routing network system based on a technology disclosed in Reference Document 1. The network configurations shown in FIGS. 15 and 16 are the same as the configuration shown in FIG. 3. FIGS. 15 and 16 indicate a case where the shortest S1-R11-R12-T1 path cannot provide a bandwidth required for data delivery in compliance with a data request from the T1. In this instance, it is assumed that the line between the R11 and R12 is congested. The figures indicate a situation where the R11-R13-R12 path can provide a bandwidth required for data delivery requested by the T1. FIG. 15 shows a data delivery path that is obtained when a request routing network system is used according to the present invention. FIG. 16 shows a data delivery path that is obtained when a request routing network system is used as described in Reference Document 1. Solid arrows 181 and 191 in FIGS. 15 and 16 indicate respective data delivery paths and the directions of data delivery. For comparison purposes, broken arrow 182 in FIGS. 15 and 16 indicates a delivery path that is adopted when a bandwidth required for S1-R11-R12-T1 data delivery is acquired. The use of a preferred embodiment of the present invention increases the router hop count by 1 when compared to a situation where the bandwidth is acquired for the S1-R1-R12-T1 path.

On the other hand, the use of a technology disclosed in Reference Document 1 increases the router hop count by 2 when compared to a situation where the bandwidth is acquired for the S1-R1-R12-T1 path. It means that the use of a preferred embodiment of the present invention reduces the delay in the T1's data reception from a server as compared to the use of a technology disclosed in Reference Document 1. In marked contrast to the use of a technology described in Reference Document 1 in which the delivery path is set across networks 1 and 2, the use of the present invention can confine the delivery path within a network near the T1, thereby avoiding a data transfer involving the other networks. As a result, the line bandwidth to be furnished in advance between networks can be decreased with a view toward price reduction.

Next, FIG. 4 is used to describe the release of a set path. After path setup, the RR1 periodically monitors the use of the path (step 616). When the bandwidth used for the path decreases below a predefined threshold, the RR1 issues a path release request to the R11 (step 617). In this instance, the path identifier of the path to be released is stored in a path release request message in the same manner as for the storage of the path identifier 113 in the path setting request message 110 shown in FIG. 9. Upon receipt of the path release request, the R11 first selects the entry to be erased from the label table in accordance with the identifier for the path to be released, and then erases the selected entry. Subsequently, the R11 issues a label release request to downstream router R13 (step 618). The value of the label to be released is stored in a label release request message. Upon receipt of the label release request, the R13 first selects the entry to be erased from the label table in accordance with the value of the label in the label release request message, and then erases the selected entry. Subsequently, the R13 issues a label release request to downstream router R12 (step 619). Upon receipt of the label release request, the R12 first selects the entry to be erased from the label table in accordance with the value of the label in the label release request message, and then erases the selected entry. In consideration of its role as an output edge router for an MPLS network, the R12 subsequently returns a label release response to upstream router R13 (step 620). Upon receipt of a label release response message, the R13 returns a label release response to upstream router R11 (step 621). Upon receipt of a label release response message, the R11 recognizes that all the labels on the path are released, and then returns a path release response to the RR1 (step 622). The identifier of the released path is stored in a path release response message in the same manner as for the storage of the path identifier 113 in the path setting response message 120 shown in FIG. 10. Upon receipt of the path release response message, the RR1 selects the path to be erased from the route management table in the RR1 in accordance with the path identifier in the path release response message, and then erases the selected path.

An unnecessary path can be released to lessen the path processing load on each router by performing a path release operation described above. Further, the above path release operation cuts down on the number of entries in the label table of each router as well as in the delivery path information table within the request router.

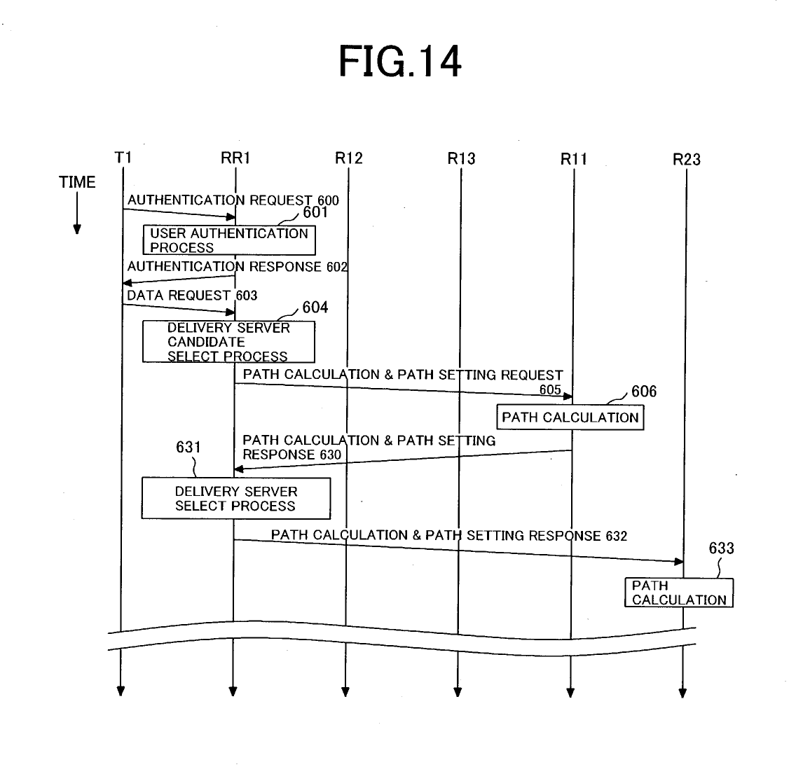

Next, FIG. 14 is used to describe the bandwidth request process that is performed in relation to the next delivery server candidate when the result of path calculation performed at the R11 indicates that no appropriate path exists. The sequence between the T1's authentication request 600 and the R11's path calculation 606 is the same as for the process described with reference to FIG. 4. If the result of path calculation 606 indicates that the requested bandwidth cannot be acquired for the path between the R11 and R12, a path calculation & path setting response 630 is returned to notify the RR1 of such a situation. In this instance, the path calculation result field 101 of the path calculation & path setting response message 100 (FIG. 8) stores a value indicating that “Path calculation has not been successful”.

Upon receipt of the above path calculation & path setting response message 100, the RR1 examines the value in the path calculation result field 101 of the path calculation & path setting response message 100 to recognize that the bandwidth for the path between the R11 and R12 has not successfully been acquired. The RR1 then removes delivery server S1, which uses the path between the R11 and R12, from a candidate list, and performs a delivery server select process 631 to select the next candidate. As a result of the delivery server select process 631, the RR1 selects the S2 as the next delivery server candidate. In this instance, the RR1 issues a path calculation & path setting request 632 to start point router R23 on the delivery path. Upon receipt of the path calculation & path setting request, the R23 performs a path calculation 633. The subsequent process is the same as described with reference to FIGS. 4 and 14.

A request routing network system according to the preferred embodiment described above also provides advantages (a) through (i), which are enumerated below.

(a) In the request routing network system, a plurality of routers interconnect a plurality of servers that retain a copy of at least one type of data, a plurality of terminals that issue requests for such data, and a request router that redirects the data requests to the servers. Upon receipt of the data requests, the request router requests one of the routers connected close to the servers to perform a path calculation/setup for delivering requested data before redirecting received data requests to the servers.

(b) In the above request routing network system, the request router includes a server select unit, a path setting unit, and a path information management table. The server select unit selects a server candidate from the aforementioned plurality of servers in accordance with specified conditions. Before request redirection, the path setting unit issues the path calculation & path setting request to the most upstream router, which is one of the routers and connected close to the above server. In accordance with the result of the above path calculation and setup, the path setting unit stores new path information set by the most upstream router in the path information management table. The selected server then uses the newly selected path to deliver the requested data to a terminal.

(c) In the above request routing network system, the aforementioned path is a list of routers ranging from the most upstream router to the most downstream router connected close to the aforementioned terminal under the conditions in which the time of delay between the aforementioned server and terminal and the associated data processing load on the server are minimized. The request router manages the delay time for the above data delivery through the path between the server and terminal and the extra bandwidth of the path as the load on the network system.

(d) In the above request routing network system, the request router notifies the most upstream router of a bandwidth required for the data delivery when it cannot acquire a necessary bandwidth for the data delivery on the path upon receipt of a data request from the terminal. The most upstream router calculates a new path in accordance with the above bandwidth for the above-mentioned path calculation/setup. The most upstream router sets the new path, if the calculation result indicates that it is possible, and notifies the aforementioned request router of the resulting new path setting. Upon receipt of the new path setting notification, the request router selects a server necessary for data delivery while considering the new path.

(e) In the above request routing network system, the request router selects the server candidate, to which the data request is redirected, and one path for delivery in accordance with conditions other than the bandwidth at the time of notifying the most upstream router of a bandwidth required for the data delivery, and checks whether the bandwidth required for data delivery can be acquired for the path. If the necessary bandwidth cannot be acquired, the request router notifies the most upstream router on the above path of the bandwidth required for the data delivery.

(f) In the above request routing network system, the request router inhibits a new path calculation/path setup process for a request routing process performed in response to a data request other than the aforementioned data request by notifying the most upstream router of a bandwidth greater than the minimum bandwidth required for the requested data delivery at the time of notifying the most upstream router of the bandwidth required for the data delivery.

(g) In the above request routing network system, the request router calculates the new path for acquiring the necessary bandwidth for the data delivery between the most upstream router on the path and the most downstream router, which is connected close to the terminal and one of a plurality of routers, when the request router cannot acquire the necessary bandwidth for the data delivery upon receipt of a data request from the terminal. If the result of the calculation indicates that the new path can be set, the request router sets the new path, and selects an optimum server for the data delivery while considering the extra bandwidth of the set path.

(h) In the above request routing network system, the request router calculates the new path for acquiring the bandwidth required for the data delivery between the most upstream router and the most downstream router on the aforementioned path in accordance with constantly collected information about the network connection status prevailing between the most upstream router and the most downstream router on the new path, the load on the routers, and the extra bandwidths of the lines for the routers.

(i) In the above request routing network system, the request router manages the extra bandwidth of a plurality of paths when such paths exist between the aforementioned server and terminal, and selects an optimum server for data delivery while considering the of paths.

The request routing processing procedure that is indicated in FIG. 4 for use with the above network system can also be offered as a path setting method having advantages (i) through (iv), which are enumerated below.

(i) The method for path setting, which is used in a network in which a plurality of routers interconnect a plurality of servers that retain a copy of various types of data, a plurality of terminals that issue a request for such data, and a request router that redirects the data request to the servers, comprises the step of causing the request router to comply with the data request from one of the above terminals and select a server candidate that is one the aforementioned servers and capable of delivering requested data under specified conditions, the step of issuing a path calculation & path setting request to a router that is close to the selected server and one of the aforementioned routers, and the step of adding new path information to the request router and redirecting the data request to the server in accordance with the result of calculation and setup.

(ii) The above method for path setting further comprises the step of causing the request router to perform a path release process in accordance with the path use by the aforementioned routers after the data delivery from the aforementioned server to terminal via the new path under specified conditions in which the time of delay between the server and terminal and the associated data processing load on the server are minimized.

(iii) In the above method for path setting, the aforementioned routers include the most downstream router that is close to the aforementioned terminal, and the most upstream router that is close to the above server calculates and sets the path after the aforementioned requesting step. If the result of the calculation indicates that a necessary bandwidth cannot be acquired for allowing the server to deliver requested data to the terminal via the most upstream router and most downstream router, a response is returned to the request router to notify that the necessary bandwidth cannot be acquired, thereby causing the request router to select a new server candidate.

(iv) In the above method for path setting, the aforementioned path is a list of routers ranging from the most upstream router, which is a router close to the aforementioned server, to the most downstream router, which is connected close to the aforementioned terminal.

Next, the operation of request router RR1 of the present invention will be detailed with reference to FIG. 1. The input interface 101 has one or more ports, and connects to servers S1, S2, and S3, terminals T1 and T2, and routers R11, R12, R13, R21, R22, R23, and R31 via one or more lines. The input interface 101 terminates a network transfer protocol and assembles a data delivery request message received from the T1/T2 and a path calculation & path setting response message, path release response message, or other message received from start point router R11/R23. If, for instance, TCP (Transmission Control Protocol), IP (Internet Protocol), or Ethernet (registered trademark) is used as a network transfer protocol, the operations performed by the input interface 101 include Ethernet (registered trademark) frame normality verification, IP packet normality verification, IP packet assembling, and TCP connection termination. The input interface 101 transfers an assembled data delivery request message, path calculation & path setting response message, and path release response message to the protocol analyze unit 102.

[User Authentication]

Next, the user authentication process 601, which is performed when the RR1 receives an authentication request from the T1, will be described with reference to FIG. 4. In the example shown in FIG. 4, the input interface 101 first establishes a communication connection to the T1 and then transfers an authentication request message 70, which is received from the T1, to the protocol analyze unit 102.

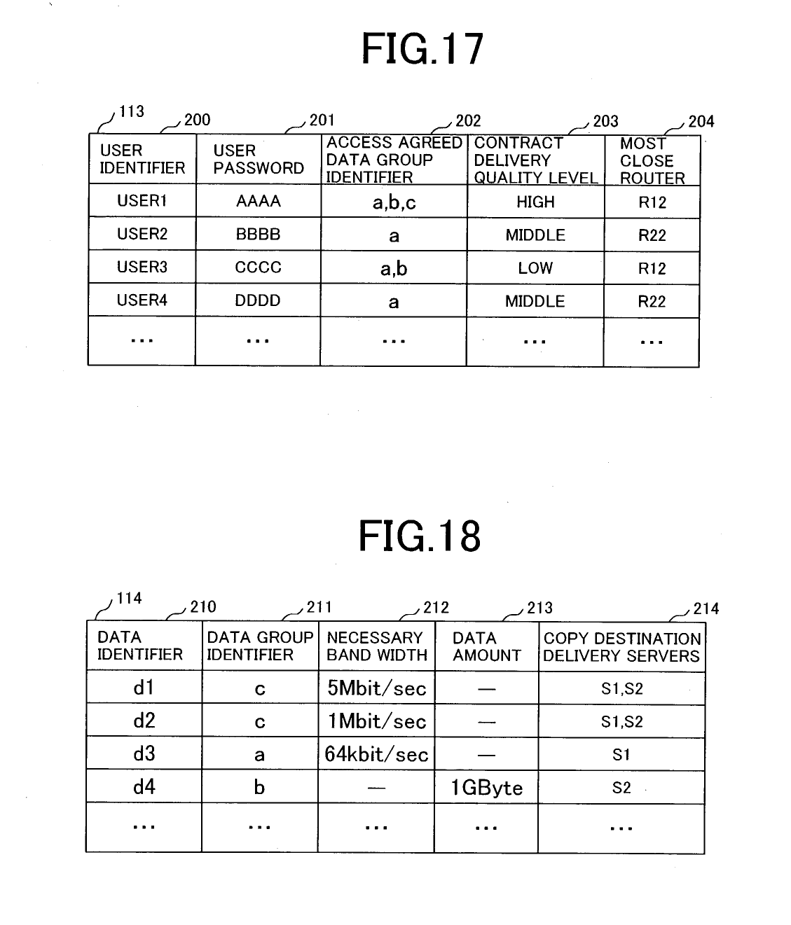

The protocol analyze unit 102 extracts the user identifier 72 and user password 73 from the user authentication request message 70 that is transferred from the input interface 101, and then transfers them to the user identification & data access authentication processing unit 111. The user identification & data access authentication processing unit 111 has the user information table 113, which is used for user authentication. FIG. 17 shows a typical structure of the user information table 113.

In the user information table 113 shown in FIG. 17, correct combinations of the user identifier 200 and user password 201 are set in advance. The user information table 113 also contains the settings for the access agreed data group identifier 202 for indicating the data group(s) that a user is authorized to access according to the contract, a user's contract delivery quality level 203, and the closest router 204, which is the router closest to a user terminal. The user's contract delivery quality level 203 is an index that specifies the stringency of quality assurance for data delivery. The settings for the user information table 113 can be entered from a network management device via the controller 107 or via the input interface 101 and protocol analyze unit 102.

The router closest to a user terminal can be set by preregistering a user network address at the time of contract signing and letting the RR1 select a router according to the network address, IP routing table, and the like. Another method is to examine the header of an IP packet that stores a data request message from a terminal as a payload, extract the source IP address from the header, and let the RR1 select a router according to the source IP address, IP routing table, and the like.

The user identification & data access authentication processing unit 111 searches the user information table 113 (FIG. 1), using the user identifier 72 and user password 73 received from the protocol analyze unit 102 as indicated in FIG. 5 as a search key, determines whether the T1 user, who has transmitted the user authentication request message 70, is authorized, and notifies the protocol analyze unit 102 of the result. In accordance with the user authentication result received from the user identification & data access authentication processing unit 111, the protocol analyze unit 102 creates a user authentication response message 80 (FIG. 6) and transmits it to the output interface 106. The output interface 106 capsules the received user authentication response according to the network transfer protocol, and transmits the capsuled response to the T1.

[Data Request Reception and Delivery Server Candidate Select Process]

Next, the delivery server candidate select process 604, which is performed when the RR1 receives a data request from the T1, will be described with reference to FIG. 1. The input interface 101 transfers the data request message 70 (FIG. 5), which is received from the T1, to the protocol analyze unit 102. The protocol analyze unit 102 extracts the user identifier 72 and data identifier 74 from the data request message 70, which is transferred from the input interface 101, and transfers the extracted identifiers to the user identification & data access authentication processing unit 111.

[User Contract and Closest Router Selection]

The user identification & data access authentication processing unit 111 searches the user information table 113 shown in FIG. 17, using the user identifier 72 received from the protocol analyze unit 102 as a search key, and decides on the user's access agreed data group identifier 202, contract delivery quality level 203, and closest router 204, which is the router closest to the user terminal. The user identification & data access authentication processing unit 111 conveys these items of information as well as the data identifier 74 (FIG. 7) to the delivery server candidate select unit 112 (FIG. 1).

[Deciding on the Required Delivery Bandwidth for Requested Data, the Data Amount, and the Copy Destination Delivery Server]

Upon receipt of the data group identifier and contract delivery quality level related to the data identifier 74 (FIG. 7), the delivery server candidate select unit 112 (FIG. 1) first searches the data management table 114, using the data identifier 74 as a search key.

FIG. 18 shows a typical structure of the data management table 114. The data management table 114 shown in FIG. 18 consists of a data identifier 210, a data group identifier 211 for indicating the group to which the data belongs, a necessary bandwidth 212, a data size 213, and a copy destination delivery server list 214 for listing the delivery servers that have copied data. The necessary bandwidth for the data to be identified by data identifier “d4” in FIG. 18 is marked “-” because it is presumed that this data is of a storage type, which is to be entirely stored in a user terminal before use, and not of a streaming type. Further, the data amount settings for the data to be identified by data identifiers “d1”, “d2”, and “d3” are marked “-” because it is presumed that these data are of a streaming type and not of a storage type.

The delivery server candidate select unit 112 (FIG. 1) searches the data management table 114 to obtain the above information. The data group identifier 211 shown in FIG. 18 is then compared against the user's access agreed data group identifier that is reported by the user identification & data access authentication processing unit 111. When an access agreed data group identifier 202 shown in FIG. 17 matches a data group identifier 211, it means that the user is permitted to request the associated data. If no data group identifier 211 matches an access agreed data group identifier, it means that the user is not permitted to request the associated data. In this instance, a data request rejection message is transmitted to the user terminal.

[Sequentially Searches the Delivery Path Information Table to Select a Path and Candidate Delivery Server]

Next, the delivery server candidate select unit 112 (FIG. 1) selects a delivery path and delivery server candidate in accordance with the delivery server information table 115, delivery path information table 116, and conditions obtained in the aforementioned processes, namely, the contract delivery quality level 203 and closest router 204 in FIG. 17 and the necessary bandwidth for data delivery 212, data amount 213, and copy destination delivery servers 214 in FIG. 18.

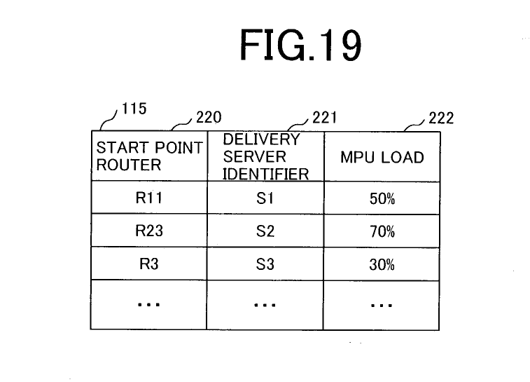

FIG. 19 shows a typical structure of the delivery server information table 115 (FIG. 1). The delivery server information table 115 shown in FIG. 19 consists of a set of entries for a start point router 220, a delivery server identifier 221, and a delivery server MPU load 222. The MPU load information about each delivery server is collected periodically by the delivery server observation unit 104 (FIG. 1). More specifically, the delivery server observation unit 104 periodically transmits a server load inspection message to each server via the protocol analyze unit 102 and output interface 106. Upon receipt of the server load inspection message, each server stores the information about its MPU load in a server load response message and transmits it to the RR1. The delivery server observation unit 104 receives the server load response messages via the input interface 101 and protocol analyze unit 102, extracts the MPU load information about each server from the server load response messages, and stores it in the associated server's MPU load fields of the delivery server information table 115 in such a manner as to overwrite the existing information.

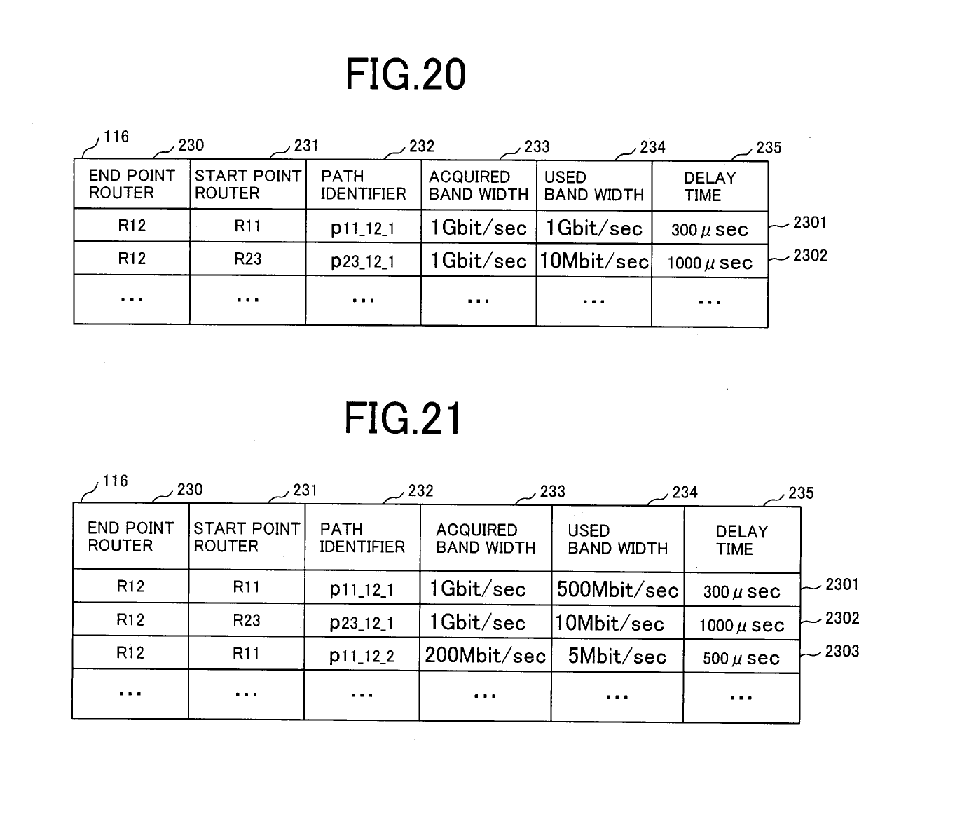

FIG. 20 shows a typical structure of the delivery path information table 116 (FIG. 1). The delivery path information table 116 shown in FIG. 20 consists of a set of entries for an end point router 230, a start point router 231, a path identifier 232 for the path set between the start point and end point routers, an acquired bandwidth 233 for the set path, a currently used bandwidth 234, and a delay time 235 that is involved between the start point and end point routers. The delay time value may represent the time that is measured from a delivery server instead of a start point router. The delivery path observation unit 105 (FIG. 1) periodically collects the information about the used bandwidth 234 and delay time 235 of each delivery path in accordance with the information about each delivery path. The used bandwidth of each delivery path can be determined by performing calculations on the statistical information about the delivery packet count and delivery packet byte count of each router on the delivery path. The statistical information can be acquired with a unique message or SNMP (Simple Network Management Protocol). For delay time measurement purposes, the RR1 may send a ping command issuance request to a start point router or delivery server to let the start point router or delivery server receive the ping command issuance request, issue a ping command to an end point router to measure the response time, and transmit the measured time to the RR1. In this instance, the ping command is used to measure the packet average response time and test a network path.

The preferred embodiment of the present invention adopts a method for performing calculations to determine whether there is a path for acquiring a requested bandwidth even when no existing route provides the requested bandwidth. Further, the first condition for delivery server candidate selection is that the delay time involved in data delivery is small, and the second condition is that the MPU load on a delivery server is light. Under these conditions, the delivery server candidate select unit 112 shown in FIG. 1 references the delay time 235 (FIG. 20) in the delivery path information 116 and the MPU load 222 (FIG. 19) in the delivery server information table 115, and selects the R11-R12 path as a path candidate and the S1 as a delivery server candidate. Subsequently, the delivery server candidate select unit 112 obtains the information about the acquired path 233 and used path 234, which are set for the path candidate “R11-R12” and shown in FIG. 20, from the delivery path information table 116, and checks whether the bandwidth necessary for data delivery is available. The delivery server candidate select unit 112 adds the bandwidth required for data delivery to the used bandwidth. If the result of this addition is smaller than the acquired bandwidth value, the delivery server candidate select unit 112 concludes that no new path setup is needed for bandwidth acquisition. If the addition result is equal to or greater than the acquired bandwidth value, the delivery server candidate select unit 112 concludes that a new path needs to be set for bandwidth acquisition. If it is assumed that the T1 requests data identifier “d1” shown in FIG. 18 according to the preferred embodiment of the present invention, the data management table 114 indicates that the bandwidth required for data delivery is 5 Mbps. Further, the path identifiers in FIG. 20 indicate that only the “p11_{—}12_{—}1” path is set as the delivery path candidate “R11-R12”, and that the acquired and used bandwidth values are both 1 Gbps. In the preferred embodiment of the present invention, therefore, the delivery server candidate select unit 112 concludes that a new path needs be set for bandwidth acquisition.

[Path Calculation/Path Setting Request Message Generation]

Upon path and delivery server candidate selection, the delivery server candidate select unit 112 shown in FIG. 1 notifies the path setting processing unit 103 of a requested bandwidth (5 Mbps in the case of the preferred embodiment of the present invention) and start point router R11. The path setting processing unit 103 transfers the above information to the protocol analyze unit 102. In accordance with start point router R11 and requested bandwidth received from the path setting processing unit 103, the protocol analyze unit 102 creates a path calculation & path setting request message and transmits it to the output interface 106. The output interface 106 capsules the path calculation & path setting request message in compliance with the network transfer protocol and transmits the resulting capsule to the R11. The delivery server candidate select process 604, which is performed when the RR1 receives a data request from the T1 as indicated in FIG. 4, has been described.

[Path Information Add Process and Data Request Redirect Process]

Next, the path information add process 612 and data request redirect process 613, which are performed when the RR1 receives a path calculation & path setting response message 100 (FIG. 8) from the R11 as shown in FIG. 4, will be described with reference to FIG. 1. The input interface 101 transfers the path calculation & path setting response message 100 to the protocol analyze unit 102. The protocol analyze unit 102 extracts the path calculation result 101, path setting result 102, set bandwidth 103, and path identifier 104, which are shown in FIG. 8, from the path calculation & path setting response message 100, and transfers them to the path setting processing unit 103. The path setting processing unit 103 notes the values set as the path calculation result 101 and path setting result 102 to recognize that a new path is set for the route between the R11 and R12. Subsequently, the path setting processing unit 103 adds a new entry to the delivery path information table 116 in accordance with the values set as the set bandwidth 103 and path identifier 104. FIG. 21 shows typical settings for the delivery path information table 116, to which the new entry described above is added. FIG. 20 shows that entries 2301 and 2302 are registered. However, FIG. 21 shows that entry 2303 is added as a new entry.

The preferred embodiment of the present invention describes an example in which a bandwidth as great as 200 Mbps is acquired for a new path in response to a data request from the T1 although the necessary bandwidth is 5 Mbps. When the acquired bandwidth is greater than the bandwidth necessary for data delivery specified by a data request as described by the preferred embodiment of the present invention, a server candidate can be selected in response to another data request while considering a newly set path. Therefore, the path calculation time and path setting time can be rendered shorter than when merely the necessary bandwidth is acquired in response to a data request. Further, it is possible to reduce the amount of data for the path calculation & path setting request message and response message to be transferred between the RR1 and each start point router and the amount of data for the path setting request message and response message to be transferred between the routers.

After adding new path information to the delivery path information table 116 shown in FIG. 1, the path setting processing unit 103 notifies the delivery server candidate select unit 112 that the new path information add process is completed. Upon receipt of the above completion notification, the delivery server candidate select unit 112 selects the S1 as the delivery server to which the data request is to be redirected, and then transfers the stored T1's data request to the protocol analyze unit 102. The protocol analyze unit 102 transfers the T1's data request to the output interface 106. The output interface 106 transmits the data request to the S1 (step 613) (FIG. 4).

Request router apparatus RR1 according to the presently preferred embodiment can also be offered as a request router apparatus having advantages (I) through (VIII), which are enumerated below.

(I) The request router apparatus comprises at least one input interface and at least one output interface, manages the load on a plurality of servers and routers distributed over a network and the load on the network via the input interface and output interface, selects a data delivery server from the plurality of servers retaining a copy of data requested by a terminal connected to the network, and redirects a data request from the terminal to the selected server. This request router apparatus includes a path setting unit. Before the above redirection, the path setting unit requests a router, which is connected close to the selected server and one of the plurality of routers, to calculate and set a new path for delivering the requested data.

(II) In the above request router apparatus, the aforementioned path is a list of routers ranging from the most upstream router, which is a router connected close to the aforementioned server, to the most downstream router connected close to the aforementioned terminal, and the delay time for data delivery through a data delivery path between the selected server and the terminal and the extra bandwidth of the path are managed as the load on the network.

(III) The above request router apparatus further comprises a delivery path information table for managing the extra bandwidth of a data delivery path between the aforementioned server and terminal. When a necessary bandwidth for data delivery cannot be acquired on a path retained by the delivery path information table upon receipt of a data request from the terminal, the aforementioned path setting unit notifies the most upstream router, which is connected close to the server, of a bandwidth required for the data delivery, and receives the path calculation and path setting results from the most upstream router. If the path setting result indicates that a new path is set, the server select unit included in the request router apparatus selects a server necessary for data delivery while considering the path.

(IV) The above request router apparatus selects one delivery path and a server candidate for redirecting a data request under the conditions where a bandwidth other than the bandwidth required for data delivery is used, and checks whether a bandwidth required for the data delivery can be acquired for the above path when notifying the aforementioned most upstream router of a bandwidth required for the data delivery. If bandwidth acquisition is not achievable, the request router apparatus notifies the most upstream router on the path of a bandwidth required for the data delivery.

(V) When notifying the aforementioned most upstream router of a bandwidth required for the above data delivery, the above request router apparatus notifies the most upstream router of a bandwidth greater than the minimum bandwidth required for the requested data delivery in order to inhibit a path calculation/path setup process at the above router within the aforementioned network during a request routing process that is performed in response to a data request other than the above data request.

(VI) The above request router apparatus has a delivery path information table for managing the extra bandwidth of the aforementioned data delivery path between the aforementioned server and terminal. If a necessary bandwidth for data delivery on a path retained by the delivery path information table cannot be acquired upon receipt of a data request from the above terminal, the request router apparatus calculates a new path for acquiring a bandwidth required for data delivery between the most upstream router on the path and the most downstream router, which is connected close to the terminal and one of the plurality of routers. If the result of the calculation indicates that the new path can be set, the request router apparatus sets the new path between the most upstream router and most downstream router, and selects an optimum server for the data delivery while considering the extra bandwidth of the set path.

(VII) The above request router apparatus is used for constantly collecting and managing the information about the line connection status, load on the plurality of routers, and extra bandwidth of the associated line between the most upstream router and most downstream router on the aforementioned path retained in the aforementioned delivery path information table, and calculating the new path for acquiring a bandwidth required for the data delivery between the most upstream router and most downstream router on the path.

(VIII) The above request router apparatus has a delivery path information table for managing the extra bandwidth of the data delivery path between the aforementioned server and terminal. If a plurality of paths exist between the server and terminal, the request router apparatus also registers the extra bandwidth of the plurality of paths in the delivery path information table for management purposes and selects an optimum server for the data delivery while considering the plurality of paths.

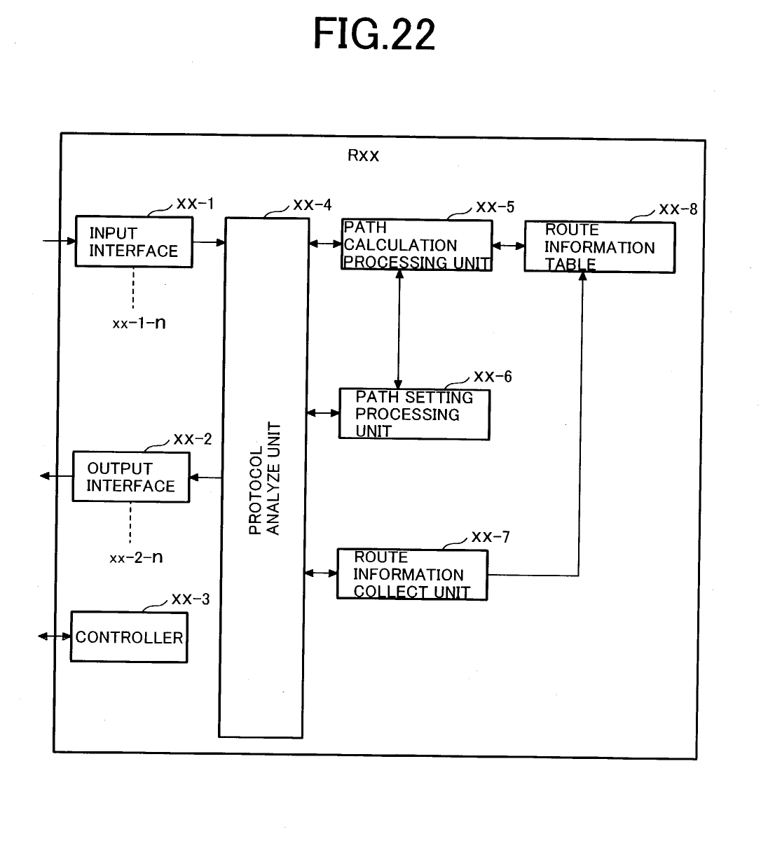

The functions of the routers (R11, R12, R13, etc.) of the present invention, which are within a network shown in FIG. 3, will be described with a router apparatus configuration block diagram in FIG. 22.

Start point router Rxx uses route information collect unit xx-7 to extract the information about interface line bandwidth accommodated by each router, the extra bandwidth, and the status of the connections to the other routers, and the like from the other routers within a network via protocol analyze unit xx-4, and stores the extracted information in route information table xx-8. In the presently preferred embodiment, router R11 corresponds to router Rxx.

When start point router Rxx receives a path calculation & path setting request message from request router RR1 via input interface xx-1, it analyzes the message with protocol analyze unit xx-4, and notifies path calculation processing unit xx-5 of an end point router and requested bandwidth. Path calculation processing unit xx-5 calculates an optimum path between the start point and end point routers so as to provide the requested bandwidth in accordance with the information stored in route information table xx-8. The optimum path is a list of routers ranging from the start point router to the end point router and equivalent to the routers list 115 shown in FIG. 9.

Path setting processing unit xx-6 receives the optimum path information (routers list), which is calculated by path calculation processing unit xx-5, stores the received list in a path setting request message 110 (FIG. 9), and transmits it to protocol analyze unit xx-5. Protocol analyze unit xx-5 packetizes the path setting request message and forwards it to downstream router R13 or the like via the output interface.

The router apparatus indicated in FIG. 22 according to the presently preferred embodiment can be offered as a router apparatus having advantages (1) through (3), which are enumerated below.

(1) The router apparatus comprises at least one input line and at least one output line to perform a packet reception or transmission operation relative to a request router installed within a network via the input line and output line and collect the used bandwidth and other information about the lines from a plurality of other routers within the network. This router apparatus includes a path calculation processing unit and a path setting processing unit. The path calculation processing unit receives a request message transferred from the aforementioned request router via the input line and performs a path calculation in accordance with the information in the route information table possessed by the router apparatus. The path setting processing unit sets a path in accordance with the result of the calculation.

(2) While a plurality of terminals, which issue a data request to the aforementioned request router, are connected to the aforementioned network, the router apparatus notes a requested bandwidth stored in the aforementioned request message and the identifier for identifying the most downstream router, which is connected close to the terminals and one of the plurality of routers, and performs a calculation to determine whether a path exists between the router apparatus and the most downstream router and acquires the requested bandwidth. When the result of the calculation indicates that an existing path can acquire the requested bandwidth, the router apparatus transmits a path setting request message to the most downstream router. Upon receipt of a path setting response message from the most downstream router, the router apparatus recognizes that a path providing the requested bandwidth is set, and transmits a path setting response message to the request router.

(3) In the above router apparatus within the aforementioned network to which a plurality of servers retaining a copy of data requested by the aforementioned terminal are connected, the aforementioned path is a list of routers ranging from the most upstream router, which is a router connected close to the servers, to the aforementioned most downstream router.

In the above-described preferred embodiment of the present invention, a path is calculated by an upstream router or start point router Rxx that has received a path calculation & path setting request message from the request router, and the path is autonomously set by each router. In the above preferred embodiment, the processing load on the request router can be reduced by allowing a router to calculate and set a path.

In an alternative embodiment of the present invention, the request router may constantly collect the information about the network configuration around each path, the bandwidths of the lines accommodated by the routers, and the like, and use the collected information to intensively calculate and set a path that provides a bandwidth required for data delivery.

The use of the above-described request router apparatus, router apparatus, and request routing network system of the present invention makes it possible to dynamically control the bandwidth on a delivery path between a delivery server and terminal in response to a data request. If the bandwidth on the delivery server is insufficient, a new path can be set to increase the bandwidth.

As a result, both the server resources and network resources can be effectively used. Therefore, high-quality data delivery services can be offered to a larger number of users without having to increase the amount of available server resources and network resources. Since the number of serviceable users can be increased, the service price per user can be maintained low.

The foregoing invention has been described in terms of preferred embodiments. However, those skilled, in the art will recognize that many variations of such embodiments exist. Such variations are intended to be within the scope of the present invention and the appended claims.

What is claimed is:

1. A request routing network system in which a plurality of routers interconnect a plurality of servers that retain a copy of at least one type of data, a plurality of terminals that issue requests for such data, and a request router that redirects said data requests to said plurality of servers,
wherein said request router requests one of the routers connected close to said servers to perform a path calculation/setup for delivering said data before redirecting received data requests to said servers.

2. The request routing network system according to claim 1, wherein:
said request router includes a server select unit, a path setting unit, and a path information management table, wherein said server select unit selects a server candidate from said plurality of servers in accordance with specified conditions;
said path setting unit issues said path calculation & path setting request to the most upstream router connected close to said server before request redirection, wherein said path setting unit stores new path information set by said most upstream router in said path information management table in accordance with the result of said path calculation and setup; and
said selected server uses said newly selected path to deliver said requested data to one of said terminals.

3. The request routing network system according to claim 2, wherein:
said path is a list of routers ranging from said most upstream router to most downstream router connected close to said terminal under the conditions in which the time of delay between said server and said terminal and the associated data processing load on said server are minimized; and
said request router manages the delay time for said data delivery through said path between said server and said terminal and the extra bandwidth of said path as the load on said network.

4. The request routing network system according to claim 2, wherein:
said request router notifies said most upstream router of a bandwidth required for said data delivery when it cannot acquire a necessary bandwidth for said data delivery on said path upon receipt of a data request from said terminal;
said most upstream router calculates a new path in accordance with said bandwidth for said path calculation and setup, wherein said most upstream router sets said new path, if the calculation result indicates that it is possible, and returns the resulting new path setting to said request router; and
said request router, upon receipt of the notification of said new path setting, selects a server necessary for data delivery while considering said new path.

5. The request routing network system according to claim 4, wherein:
said request router selects said server candidate, to which said request is redirected, and one path for delivery in accordance with conditions other than said bandwidth, and checks whether the bandwidth required for data delivery can be acquired for said path when notifying said most upstream router of a bandwidth required for said data delivery; and
said request router, if the necessary bandwidth cannot be acquired, notifies said most upstream router on said path of the bandwidth required for said data delivery.

6. The request routing network system according to claim 3, wherein said request router inhibits a new path calculation/path setup process for a request routing process performed in response to a data request other than said data request by notifying said most upstream router of a bandwidth greater than the bandwidth required for said requested data delivery at the time of notifying the most upstream router of said bandwidth required for said data delivery.

7. The request routing network system according to claim 2, wherein:
said request router calculates said new path for acquiring said necessary bandwidth for said data delivery between said most upstream router on said path and the most downstream router, which is connected close to said terminal and one of said plurality of routers, when said request router cannot acquire said necessary bandwidth for said data delivery upon receipt of a data request from said terminal; and
said request router sets said new path, if the result of said calculation indicates that said new path can be set, and selects an optimum server for said data delivery while considering the extra bandwidth of said set path.

8. The request routing network system according to claim 7, wherein said request router calculates said new path for acquiring said bandwidth required for said data delivery between said most upstream router and said most downstream router on said path in accordance with constantly collected information about the network connection status between said most upstream router and said most downstream router on said new path, the load on said plurality of routers, and the extra bandwidths of the lines for said plurality of routers.

9. The request routing network system according to claim 2 or 3, wherein said request router manages the extra bandwidth of a plurality of paths when said plurality of paths exist between said server and said terminal, and selects an optimum server for data delivery while considering the extra bandwidth of said plurality of paths.

10. A request router apparatus comprising at least one input interface and at least one output interface, wherein:
said apparatus manages the load on a plurality of servers and routers distributed over a network and the load on the network via said input interface and output interface, selects a data delivery server from said plurality of servers retaining a copy of data requested by a terminal connected to said network, and redirects a data request from said terminal to said selected server;
said request router apparatus includes a path setting unit; and
said path setting unit, before said redirection, requests a router, which is connected close to said selected server and one of said plurality of routers, to calculate and set a new path for delivering said requested data.

11. The request router apparatus according to claim 10, wherein said path is a list of routers ranging from the most upstream router, which is a router connected close to said server, to the most downstream router connected close to said terminal, and the delay time for data delivery through a data delivery path between said selected server and said terminal and the extra bandwidth of said path are managed as the load on said network system.

12. The request router apparatus according to claim 10 or 11, further comprising a delivery path information table for managing the extra bandwidth of a data delivery path between said server and said terminal, wherein:
said path setting unit notifies the most upstream router, which is connected close to said server, of a bandwidth required for said data delivery when it cannot acquire a necessary bandwidth for data delivery on a path retained by said delivery path information table upon receipt of a data request from said terminal, and receives the result of calculation and setup of said path from the most upstream router; and
a server select unit included in said request router apparatus selects a server necessary for data delivery while considering said path if a new path is set as a result of said path setup.

13. The request router apparatus according to claim 12, wherein:
said apparatus selects one delivery path and a server candidate for redirecting a data request in accordance with conditions other than said bandwidth, and checks whether a bandwidth required for said data delivery can be acquired for said path when notifying said most upstream router of a bandwidth required for said data delivery; and
said request router apparatus notifies said most upstream router on said path of a bandwidth required for said data delivery if the necessary bandwidth can not be acquired.

14. The request router apparatus according to claim 12, wherein said request router inhibits a new path calculation/path setup process for a request routing process performed in response to a data request other than said data request by notifying said most upstream router of a bandwidth greater than the bandwidth required for said requested data delivery at the time of notifying the most upstream router of said bandwidth required for said data delivery.

15. The request router apparatus according to claim 10, further comprising a delivery path information table for managing the extra bandwidth of-said data delivery path between said server and said terminal, wherein:
said request router calculates said new path for acquiring said necessary bandwidth for said data delivery between said most upstream router on said path and the most downstream router, which is connected close to said terminal and one of said plurality of routers, when said request router cannot acquire said necessary bandwidth for said data delivery upon receipt of a data request from said terminal; and
said request router sets said new path, if the result of said calculation indicates that said new path can be set, and selects an optimum server for said data delivery while considering the extra bandwidth of said set path.

16. The request router apparatus according to claim 15, wherein said apparatus constantly collects and manages the information about the line connection status, load on said plurality of routers, and extra bandwidth of the associated line between said most upstream router and most downstream router on said path retained in said delivery path information table, and calculates said new path for acquiring a bandwidth required for said data delivery between said most upstream router and most downstream router on said path.

17. The request router apparatus according to claim 10, wherein:
said apparatus retains a delivery path information table for managing the extra bandwidth of said data delivery path between said server and said terminal; and
said apparatus also registers the extra bandwidth of plurality of paths in said delivery path information table for management purposes if said plurality of paths exist between said server and said terminal, and selects an optimum server for said data delivery while considering said plurality of paths.

18. A router apparatus comprising at least one input line and at least one output line to perform a packet reception or transmission operation relative to a request router installed within a network via said input line and output line and collect the used bandwidth and other information about the lines from a plurality of other routers within the network, wherein:
said router apparatus includes a path calculation processing unit and a path setting processing unit;
said path calculation processing unit receives a request message transferred from said request router via said input line and performs a path calculation in accordance with the information in a route information table possessed by said router apparatus; and
said path setting processing unit sets a path in accordance with the result of said calculation.

19. The router apparatus according to claim 18, wherein:
a plurality of terminals, which issue a data request to said request router, are connected to said network, and said router apparatus notes a requested bandwidth stored in said request message and the identifier for identifying the most downstream router, which is connected close to said terminals and one of said plurality of routers, and performs a calculation to determine whether a path exists between said router apparatus and said most downstream router and acquires said requested bandwidth; and
said router apparatus transmits a path setting request message to said most downstream router when the result of said calculation indicates that a path exists to provide said requested bandwidth, recognizes upon receipt of a path setting response message from said most downstream router that a path providing said requested bandwidth is set, and transmits a path setting response message to said request router.

20. The router apparatus according to claim 19, wherein a plurality of servers retaining a copy of data requested by said terminal are connected to said network, and wherein said path is a list of routers ranging from the most upstream router, which is a router connected close to said servers, to said most downstream router.

21. A method for path setting in a network in which a plurality of routers interconnect a plurality of servers that retain a copy of various types of data, a plurality of terminals that issue a request for such data, and a request router that redirects said data request to said plurality of servers, comprising the steps of:
causing said request router to select a server candidate that is one of said servers and capable of delivering said data under specified conditions in accordance with said data request from one of said terminals;
issuing a path calculation & path setting request to a router that is close to said selected server and one of said plurality of routers; and
adding new path information to said request router and redirecting said data request to said server in accordance with the result of said calculation and setup.

22. The method for path setting according to claim 21, further comprising the step of causing said request router to perform a path release process in accordance with the path use by said plurality of routers after said data delivery from said server to said terminal via said new path under specified conditions in which the time of delay between said server and said terminal and the associated data processing load on said server are minimized.

23. The method for path setting according to claim 21, wherein:
said plurality of routers include the most downstream router that is close to said terminal and the most upstream router that is close to said server calculates and sets said path after said requesting step; and
if the result of said calculation indicates that a necessary bandwidth cannot be acquired for allowing said server to deliver said requested data to said terminal via said most upstream router and most downstream router, a response is returned to said request router to notify that the necessary bandwidth cannot be acquired, thereby causing said request router to select a new server candidate.

24. The method for path setting according to claim 21, wherein said path is a list of routers ranging from the most upstream router, which is a router close to said server, to the most downstream router, which is connected close to said terminal.
